(19) United States
(12) Patent Application Publication
(10) Pub. No.: US 2006/0119289 A1
(43) Pub. Date: Jun. 8, 2006

(54) Accelerating circuit that can increase speed of LED to turn on/off

(75) Inventor: Kuo-Chen Tsai, Hsinchu (TW)

Correspondence Address: COOPER & DUNHAM, LLP, 1185 AVENUE OF THE AMERICAS, NEW YORK, NY, 10036, US

(73) Assignee: Silicon Touch Technology Inc.

(21) Appl. No.: 11/290,949

(22) Filed: Nov. 28, 2005

(30) Foreign Application Priority Data
Dec. 7, 2004 (TW) 093137712

(51) Int. Cl. H05B 41/36; H05B 37/02

(52) U.S. Cl. 315/291

(57) ABSTRACT

An accelerating circuit increases the speed of an LED (light-emitting diode) by controlling an LED driving circuit. The LED driving circuit includes two driving transistors. The accelerating circuit includes a pair of series-connected switch units and a pulse generator. The two switch units respectively connect to a first electronic source and a second electronic source. A node point where the two switch units connect together is coupled to a cathode of the LED. The pulse generator includes two input terminals to receive a pair of driving signals to control the switch units to be connected/disconnected in accordance with a pair of output pulse signals of different timing. When the switch units are connected, the two electronic sources can generate forward pulse current/reverse pulse current to deliver the forward pulse current/reverse pulse current to the LED to turn on/off the LED quickly.

### BACKGROUND OF THE INVENTION

1. Field of the Invention

The invention relates to an accelerating circuit that can increase the speed of an LED (light-emitting diode) to be turned on/off without changing the conventional driving circuit of the LED, particularly.

2. Description of the Related Art

As LED manufacturing technology advances, higher speed LEDs are available now and are used to transmit signals, such as in a photo link application. The speed of an LED is not satisfactory, however, for higher speed applications, such as for use in high-end audiovisual equipment.

FIG. 7 illustrates a control circuit diagram for an LED 50. Waveforms of driving signals A1 and A2, an LED current Ip and an optical power P_{O} on the control circuit of FIG. 7 is shown in FIG. 8. The conventional control circuit includes a pair of driving transistors 51, 52 that work together to control the LED 50 to be turned on/off. Driving signals for the two driving transistors 51, 52 form complementary waveforms A1 and A2. Even though the rising time of the LED current I_{F} is fast, the rising time of the optical power P_{O} is still slow due to the limitations of the lighting characteristics of the LED 50. So is the falling time of the optical power P_{O}. Hence the conventional LED still has a lot of room for improvement.

### SUMMARY OF THE INVENTION

An accelerating circuit of the present invention can speed up on/off operations of an LED without changing the original driving circuit of the LED, so as to turn on/off the LED quickly and also maintain a stable optical power of the LED.

In order to achieve the above-mentioned objective, a main technique of the present invention is to make use of the forward/reverse pulse currents delivered to the LED, so as to make the LED be turned on/off quickly.

With the above technique, a main feature of the present invention is to make use of providing a normal current with a stronger current pulse to the LED so the LED can be turned on quickly and have ideal illumination.

A preferred embodiment of the accelerating circuit in includes a pair of series-connected switch units, a pulse generator and an optional buffer.

### BRIEF DESCRIPTION OF THE DRAWING

FIG. 1 shows a circuit block diagram of a first embodiment of an accelerating circuit in accordance with the present invention.

FIG. 2 shows waveforms in the circuit of FIG. 1.

FIG. 3 shows a first embodiment of a pair of switch units of the present invention.

FIG. 4 shows a second embodiment of a pair of switch units of the present invention.

FIG. 5 shows a block diagram of a second embodiment of the accelerating circuit in accordance with the present invention.

FIG. 6 shows waveforms on the circuit of FIG. 5.

FIG. 7 shows a conventional driving circuit diagram for an LED (light-emitting diode).

FIG. 8 shows a waveform diagram of the circuit in FIG. 7.

### DETAILED DESCRIPTION OF THE INVENTION

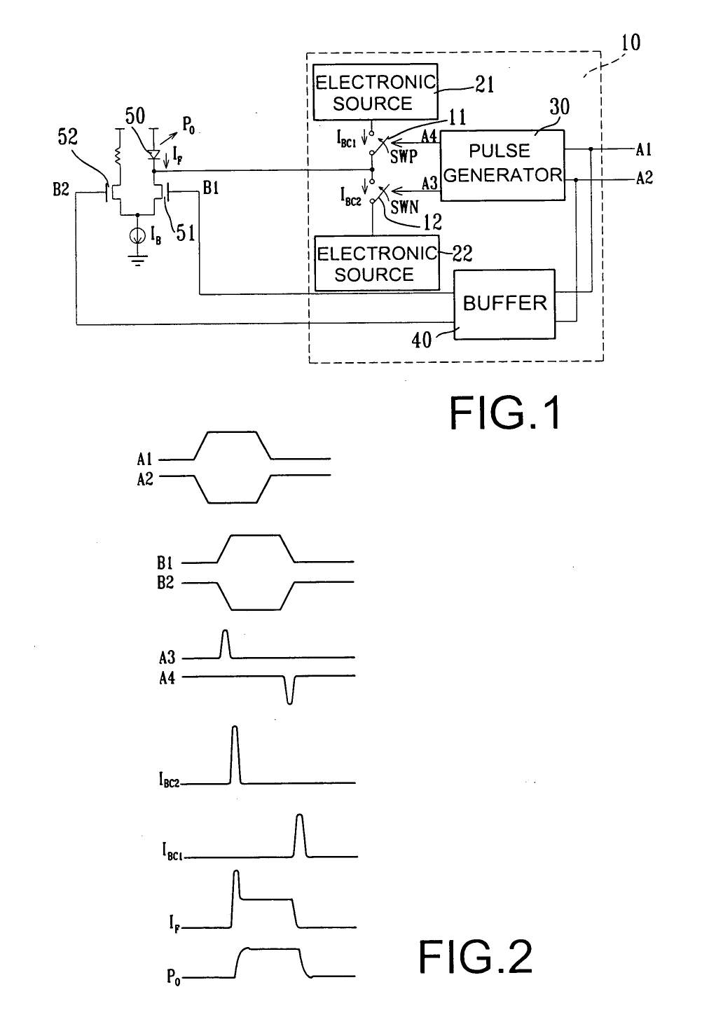

With reference to FIG. 1, a first embodiment of an accelerating circuit 10 in accordance with the present invention is used to control a driving circuit for an LED (light-emitting diode) 50. The driving circuit includes two driving transistors 51 and 52. The LED 50 is connected between a power terminal VCC and one driving transistor 51.

The accelerating circuit 10 includes a pair of switch units 11 and 12 connected in series, a pulse generator 30 and an optional buffer 40.

The pair of the switch units 11 and 12 includes two terminals, which receive respectively a first electronic source 21 and a second electronic source 22. A node where the switch units 11 and 12 are connected together is coupled to a cathode of the LED 50.

The pulse generator 30 includes two input terminals to receive a pair of complementary driving signals A1 and A2. The pulse generator 30 includes two output terminals for outputting output pulse signals of different timing, which are a first pulse signal A3 and a second pulse signal A4, to control the switch units 11 and 12 to be connected/disconnected.

The optional buffer 40 includes two input terminals coupled to the driving signals A1 and A2 and two output terminals coupled to the two driving transistors 51 and 52 to delay the driving signals A1 and A2. However, the optional buffer 40 is not an essential component in the present invention. The importance of the timing difference of the control signal would determine whether or not the buffer 40 has to be configured. A configuration condition of the buffer 40 will be described in a later paragraph.

The first electronic source 21 can be a voltage source or a current source. The second electronic source 22 can be a voltage source, a current source or a ground. The first electronic source 21 and the second electronic source 22 can collocate to generate a pulse current I_{BC1} or a pulse current I_{BC2} when either the switch unit 11 or the switch unit 12 is connected.

With reference to FIG. 2, an operation principle of the accelerating circuit 10 is illustrated. Taking an operation of activating the LED 50 as an example:

The pulse generator 30 generates the pulse signal A3 based on the rising edge of the driving signal A1 or the falling edge of the driving signal A2. When the pulse signal A3 causes the switch unit 12 to be connected, the second electronic source 22 provides the forward pulse current I_{BC2} to the LED 50. At this moment, the driving transistor 51 is triggered by a delayed driving signal B1 to generate a forward current F. A notable point is that a front part of the forward current IF includes the forward pulse current I_{BC2}; hence the LED 50 is driven by a higher current I_{BC2} in the beginning. An optical power P_{O} of the LED 50 can reach a required level within a very short time, so as to reach a required luminance. After the LED 50 is turned on, the forward current IF returns to a lower normal value to stabilize the optical power P_{O}.

On the other hand, when the LED 50 is turned off, the pulse generator 30 generates the reverse pulse signal A4 in accordance with the rising edge of the driving signal A2 or the falling edge of the driving signal A1. When the reverse pulse signal A4 causes the switch unit 11 to be connected, the first electronic source 21 provides the reverse pulse current I_{BC1} to the LED 50. At this moment, the driving transistor 51 is disconnected, and the LED 50 is influenced by the reverse pulse current I_{BC1} to make the optical power P_{O} return to zero within a very short time, so as to turn off the LED 50 quickly.

In the above-described circuit operation, the buffer 40 delays the original driving signals A1, A2 to become the delayed driving signals B1, B2. The pulse signals A3, A4 are generated by the pulse generator 30 when the two the original driving signals A1, A2 are input to the pulse generator 30, however this process might have some delay. In order to synchronize the pulse signals A3, A4 with the driving signals for the two transistors 51, 52, the buffer 40 is used to delay the original driving signals A1, A2 so as to derive the delayed signals B1, B2. Hence when the driving transistor 51 receives the delayed driving signal B1 to be turned on/off, the forward current I_{F} can almost be synchronous in acquiring the pulse current I_{BC2}/I_{BC1}. The buffer 40 is added in the circuit to meet the demand for highly synchronous timing. However, if highly synchronous timing is unnecessary, the buffer 40 can be omitted in the accelerating circuit 10.

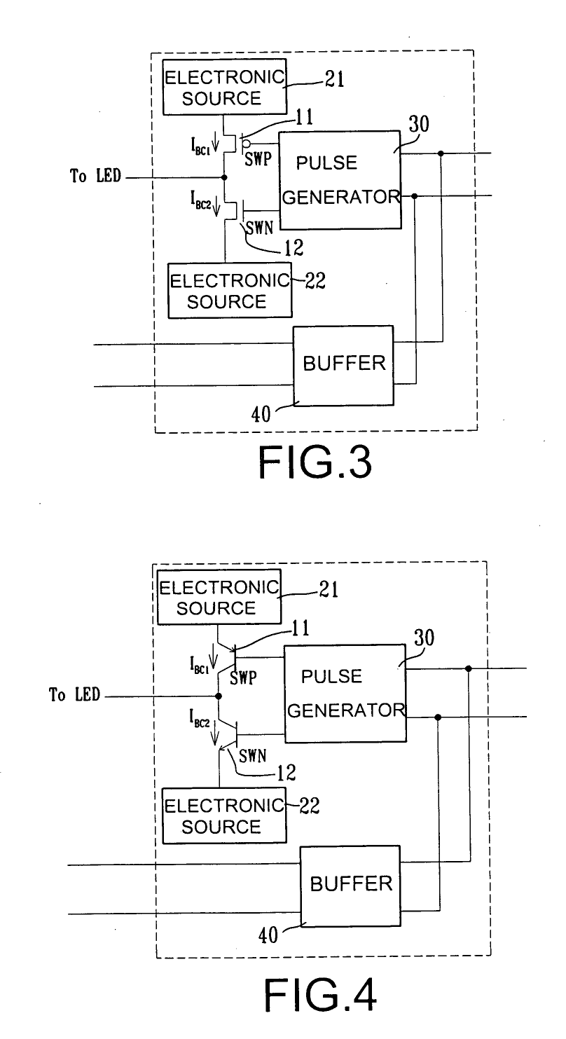

With reference to FIG. 3, the two switch units 11, 12 can be comprised of a P-type MOS transistor and an N-type MOS transistor. With reference to FIG. 4, the two switch units 11, 12 can be comprised of a PNP-type BJT (bipolar junction transistor) transistor and a NPN-type BJT transistor. However, other types of switches also can be used for the two switch units 11, 12. The types of the two switch units 11, 12 are not limited to the two examples in FIG. 3 and FIG. 4.

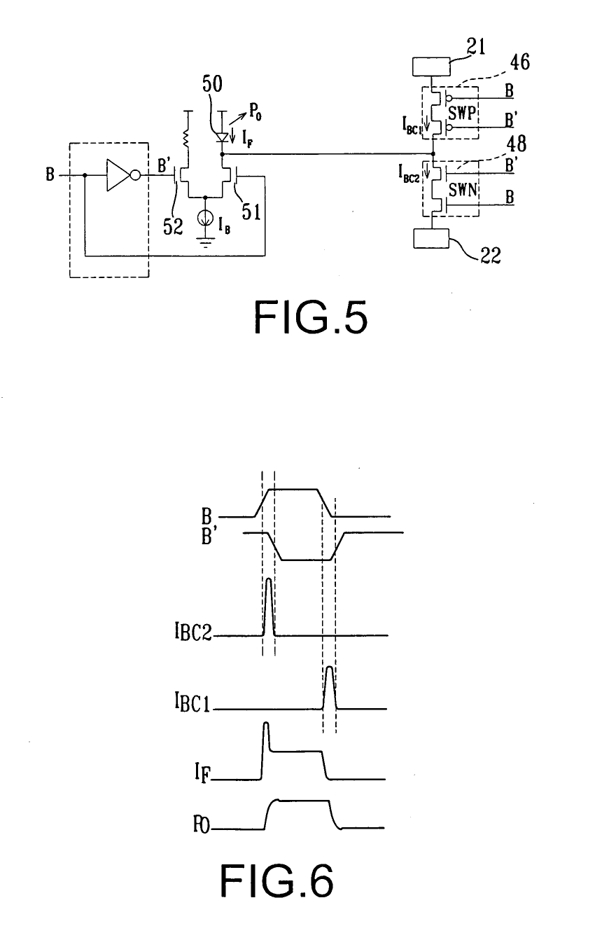

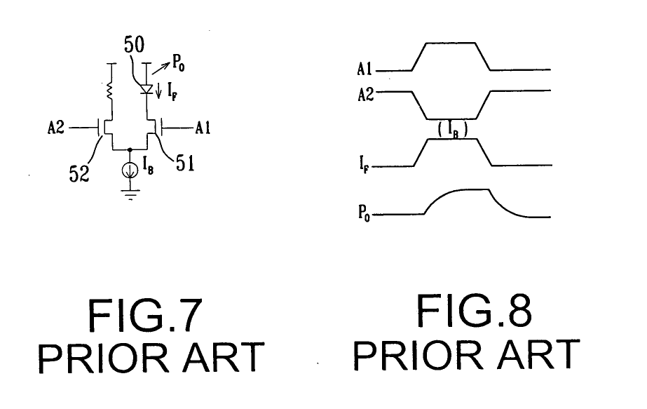

With reference to FIG. 5, a driving circuit of an LED (light-emitting diode) 50 in a left part of the diagram is coupled to an accelerating circuit in accordance with a second embodiment of the present invention in a right part of the diagram. The driving circuit includes two driving transistors 51 and 52. The LED 50 is connected between a power terminal VCC and one driving transistor 51. Two complementary driving signals B and B′ for the two driving transistors 51 and 52 are shown in FIG. 6.

In addition, the accelerating circuit includes a pair of a first switch unit 46 and a second switch unit 48 connected in series. Each of the switch units 46, 48 is respectively comprised of two series-connected switch components to receive the complementary driving signals B and B′. For example, the first switch unit 46 is comprised of two P-type MOS transistors connected in series and the second switch unit 48 is comprised of two N-type MOS transistors connected in series.

With collocation of the two switch units 46, 48, the embodiment of the present invention can also generate the pulse currents I_{BC2} and I_{BC1}. The pulse currents I_{BC2} and I_{BC2} can also be delivered to the LED 50 to acquire the same effect as the first embodiment. It is clear that the circuit architecture in FIG. 5 is much simpler than the circuit architecture in FIG. 1. The circuit architecture in FIG. 5 uses less components, so as to reduce cost effectively.

With the above detailed description, a main feature of the present invention is to make use of providing a normal current with a stronger current pulse to an LED to turn on the LED be quickly and have ideal illumination. Furthermore, the present invention also takes the stability of the illumination into consideration, so as to provide a pulse current to the LED via the additional accelerating circuit to conduct and turn on the LED within a very short time. With the same principle, the accelerating circuit also generates the other pulse current to the LED corresponding to the driving signal, so as to completely turn off the LED quickly.

Therefore, the present invention can increase the speed of an LED, which is much faster than the conventional LED, so as to include an inventive step of an invention patent.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An accelerating circuit that increases the speed of an LED (light-emitting diode) to turn on/off by controlling an LED driving circuit that includes two driving transistors, wherein the accelerating circuit comprises:
two switch units connected in series and receiving respectively a first electronic source and a second electronic source, wherein a node point where the two switch units connected together is coupled to a cathode of the LED;
a pulse generator comprising two input terminals to respectively receive a first driving signal and a second driving signal to control the two switch units to be connected/disconnected in accordance with a pair of output pulse signals of different timing;
wherein when the switch units are connected, the two electronic sources can generate a forward pulse current and a reverse pulse current to deliver the forward pulse current and the reverse pulse current to the LED to turn on/off the LED quickly.

2. The accelerating circuit as claimed in claim 1 further comprising a buffer, wherein two input terminals of the buffer are coupled to the driving signals and two output terminals of the buffer are coupled to the two driving transistors to delay the driving signals.

3. The accelerating circuit as claimed in claim 1, wherein the first electronic source is a voltage source or a current source.

4. The accelerating circuit as claimed in claim 1, wherein the second electronic source is a voltage source, a current source or a ground.

5. The accelerating circuit as claimed in claim 3, wherein the forward pulse current is generated in the vicinity of a rising edge of a activating signal or a falling edge of a deactivating signal; and the reverse pulse current is generated in the vicinity of a falling edge of the activating signal or a rising edge of the deactivating signal.

6. The accelerating circuit as claimed in claim 4, wherein the forward pulse current is generated in the vicinity of a rising edge of a activating signal or a falling edge of a deactivating signal; and the reverse pulse current is generated in the vicinity of a falling edge of the activating signal or a rising edge of the deactivating signal.

7. The accelerating circuit as claimed in claim 1, wherein the two switch units are comprised of a P-type MOS transistor and a N-type MOS transistor connected in series.

8. The accelerating circuit as claimed in claim 1, wherein the two switch units are comprised of a PNP-type transistor and a NPN-type transistor connected in series.

9. An accelerating circuit that increases the speed of an LED (light-emitting diode) to turn on/off by controlling a LED driving circuit that provides a pair of complementary driving signals applied to two driving transistors, respectively, wherein the accelerating circuit comprises:
two switch units connected in series between a first electronic source and a second electronic source, wherein a node where the two switch units connected together is coupled to a cathode of the LED;
wherein the two switch units simultaneously receive the complementary driving signals of the LED driving circuit, so that the two electronic sources generate a forward pulse current and a reverse pulse current to be delivered to the LED so as to turn on/off the LED quickly.

10. The accelerating circuit as claimed in claim 9, wherein each switch unit is made up by two switch components connected in series.

11. The accelerating circuit as claimed in claim 9, wherein the first electronic source is a voltage source or a current source.

12. The accelerating circuit as claimed in claim 9, wherein the second electronic source is a voltage source, a current source or a ground.

13. The accelerating circuit as claimed in claim 10, wherein the first switch unit is comprised of two P-type MOS transistors connected in series and the second switch unit is comprised of two N-type MOS transistors connected in series.

14. The accelerating circuit as claimed in claim 10, wherein the first switch unit is comprised of two PNP-type transistors connected in series and the second switch unit is comprised of two NPN-type transistors connected in series.

15. The accelerating circuit as claimed in claim 11, wherein the forward pulse current is generated in the vicinity of a rising edge of an activating signal or a falling edge of a deactivating signal; and the reverse pulse current is generated in the vicinity of a falling edge of the activating signal or a rising edge of the deactivating signal.

16. The accelerating circuit as claimed in claim 12, wherein the forward pulse current is generated in the vicinity of a rising edge of an activating signal or a falling edge of a deactivating signal; and the reverse pulse current is generated in the vicinity of a falling edge of the activating signal or a rising edge of the deactivating signal.

17. The accelerating circuit as claimed in claim 13, wherein the forward pulse current is generated in the vicinity of a rising edge of an activating signal or a falling edge of a deactivating signal; and the reverse pulse current is generated in the vicinity of a falling edge of the activating signal or a rising edge of the deactivating signal.

18. The accelerating circuit as claimed in claim 14, wherein the forward pulse current is generated in the vicinity of a rising edge of an activating signal or a falling edge of a deactivating signal; and the reverse pulse current is generated in the vicinity of a falling edge of the activating signal or a rising edge of the deactivating signal.
